(19) United States
(12) Patent Application Publication
(10) Pub. No.: US 2026/0121678 A1
(43) Pub. Date: Apr. 30, 2026

(54) MOBILE PHONE CASE

(71) Applicant: Douglas Butler, Bethlehem, PA (US)

(72) Inventor: Douglas Butler, Bethlehem, PA (US)

(21) Appl. No.: 18/925,254

(22) Filed: Oct. 24, 2024

(51) Int. Cl. H04B 1/3888; G06F 1/16

(52) U.S. Cl. CPC H04B 1/3888; G06F 1/1603

(57) ABSTRACT

A mobile phone case includes a back wall, a peripheral wall, and a sun-shade wall. The peripheral wall is positioned about and extending perpendicularly from a perimeter edge of the back wall. The peripheral wall is designed to extend around a mobile phone in the mobile phone case. The peripheral wall includes a top wall portion, a bottom wall portion, a first side wall portion, and a second side wall portion. The sun-shade wall is integrally formed with and projects from the peripheral wall in a direction perpendicular to the back wall. The sun-shade wall is U-shaped and extends along the first side wall, the top wall, and the second side wall of the peripheral wall.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to mobile phone accessories and more particularly pertains to a new mobile phone case that includes a sun-shade wall to shade a screen of a mobile phone held in the mobile phone case. Sun shades are commonly used to reduce glare and reflection of natural and artificial light. However, these designs are often complex and bulky, thereby requiring that the sun shades be detachable and/or collapsible so that the mobile phone can be easily stored and handled. The new mobile phone case has a low profile sun-shade wall built into the peripheral walls of the mobile phone case, which allows the user to have a permanent shade that is always available but easily transported.

### (2) Description of Related Art Including Information Disclosed Under 37 CFR 1.97 and 1.98

The prior art relates to mobile phone accessories. The prior art, as best understood, does not disclose a mobile phone case that includes a sun-shade wall that is integrally formed with and projects from a peripheral wall of the mobile phone case, wherein the sun-shade wall is U-shaped.

### BRIEF SUMMARY OF THE INVENTION

An embodiment of the disclosure meets the needs presented above in a mobile phone case generally comprising a back wall, a peripheral wall, and a sun-shade wall. The peripheral wall is positioned about and extending perpendicularly from a perimeter edge of the back wall. The peripheral wall is designed to extend around a mobile phone in the mobile phone case. The peripheral wall includes a top wall portion, a bottom wall portion, a first side wall portion, and a second side wall portion. The sun-shade wall is integrally formed with and projects from the peripheral wall in a direction perpendicular to the back wall. The sun-shade wall is U-shaped and extends along the first side wall, the top wall, and the second side wall of the peripheral wall.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a mobile phone case according to an embodiment of the disclosure.

FIG. 2 is a front view of an embodiment of the disclosure.

FIG. 3 is a side view of an embodiment of the disclosure.

FIG. 4 is a cross-sectional view of the embodiment of the disclosure in FIG. 2.

FIG. 5 is a perspective view of an embodiment of the disclosure in use.

FIG. 6 is a perspective view of an alternative embodiment of the disclosure.

### DETAILED DESCRIPTION OF THE INVENTION

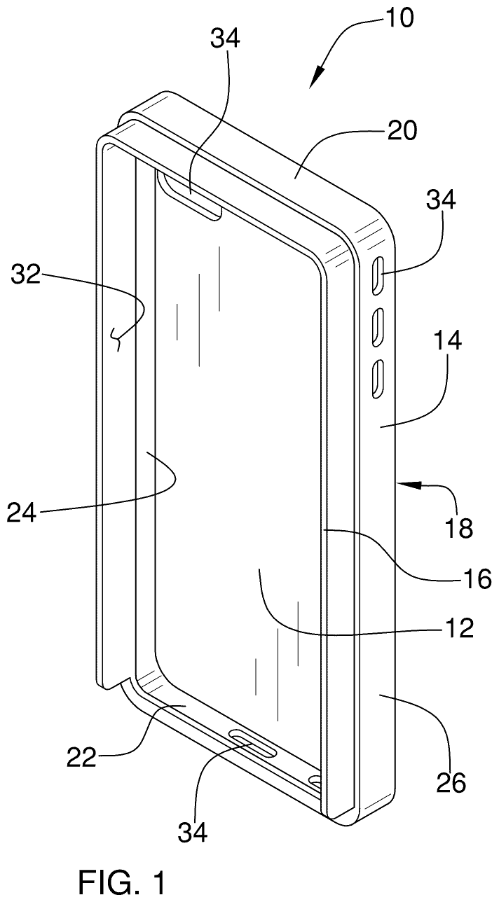

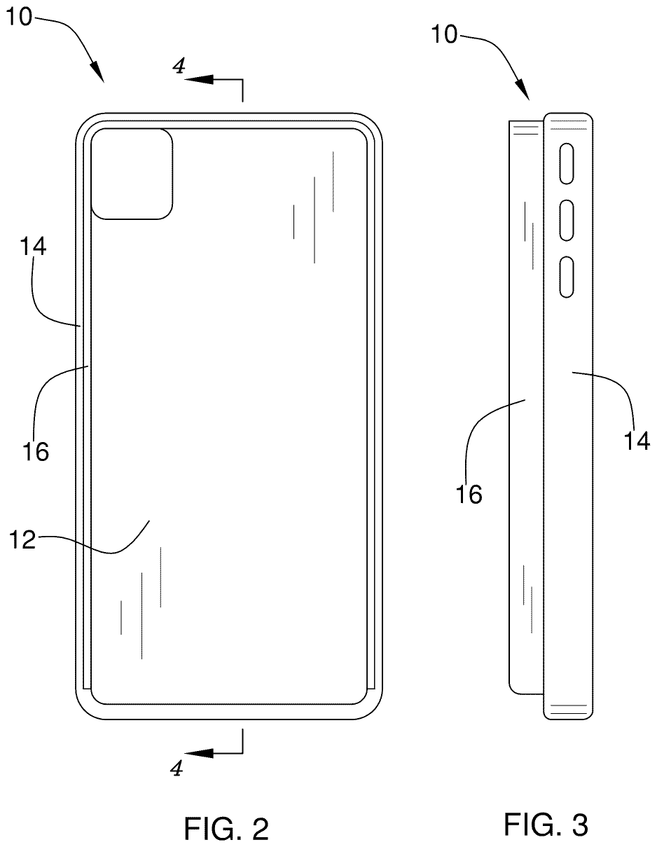

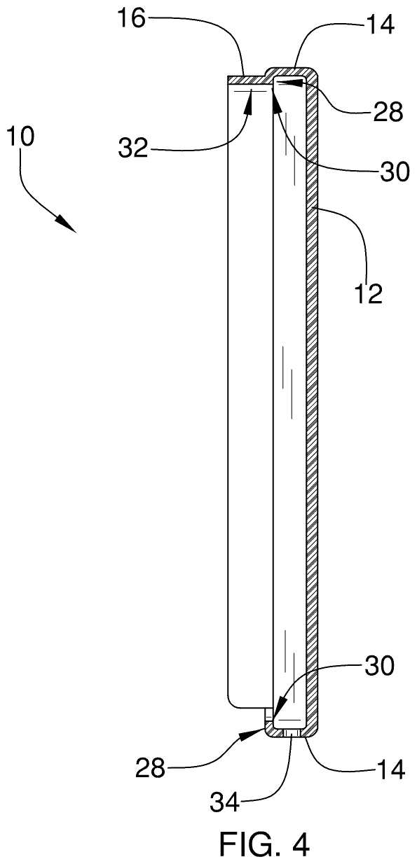

With reference now to the drawings, and in particular to FIGS. 1 through 6 thereof, a new mobile phone case embodying the principles and concepts of an embodiment of the disclosure and generally designated by the reference numeral 10 will be described.

As best illustrated in FIGS. 1 through 6, the mobile phone case 10 generally comprises a back wall 12, a peripheral wall 14, and a sun-shade wall 16. The peripheral wall 14 is positioned about and extending perpendicularly from a perimeter edge 18 of the back wall 12. The peripheral wall 14 is designed to extend around a mobile phone 60 in the mobile phone case 10. The peripheral wall 14 includes a top wall portion 20, a bottom wall portion 22, a first side wall portion 24, and a second side wall portion 26. The sun-shade wall 16 is integrally formed with and projects from the peripheral wall 14 in a direction perpendicular to the back wall 12. The sun-shade wall 16 is U-shaped and extends along the first side wall portion 24, the top wall portion 20, and the second side wall portion 26 of the peripheral wall 14.

The peripheral wall 14 includes a perimeter lip portion 28 extending along the peripheral wall 14 and projecting inwardly in a direction parallel to the back wall 12. The perimeter lip portion 28 is designed to retain the mobile phone 60 in the mobile phone case 10. The perimeter lip portion 28 includes a perimeter lip edge 30. The sun-shade wall 16 has an inner surface 32 that extends from the perimeter lip edge 30 of the perimeter lip portion 28. This design ensures that the sun-shade wall 16 is as close as possible to the mobile phone 60 to better shade a screen of the mobile phone 60.

In the exemplary embodiment shown in FIG. 3, the sun-shade wall 16 has a height similar to a height of the peripheral wall 14. This design maintains a relatively low overall profile of the mobile phone case 10 to facilitate storage, such as in pockets of clothing. However, in other possible embodiments, the sun-shade wall 16 could be higher or lower in height. In another possible embodiment, the sun-shade wall 16 could vary in height in different sections.

The mobile phone case 10 includes openings 34 in at least one of the back wall 12 and the peripheral wall 14 to permit access to components and ports of the mobile phone 60, as is well known in the mobile phone industry.

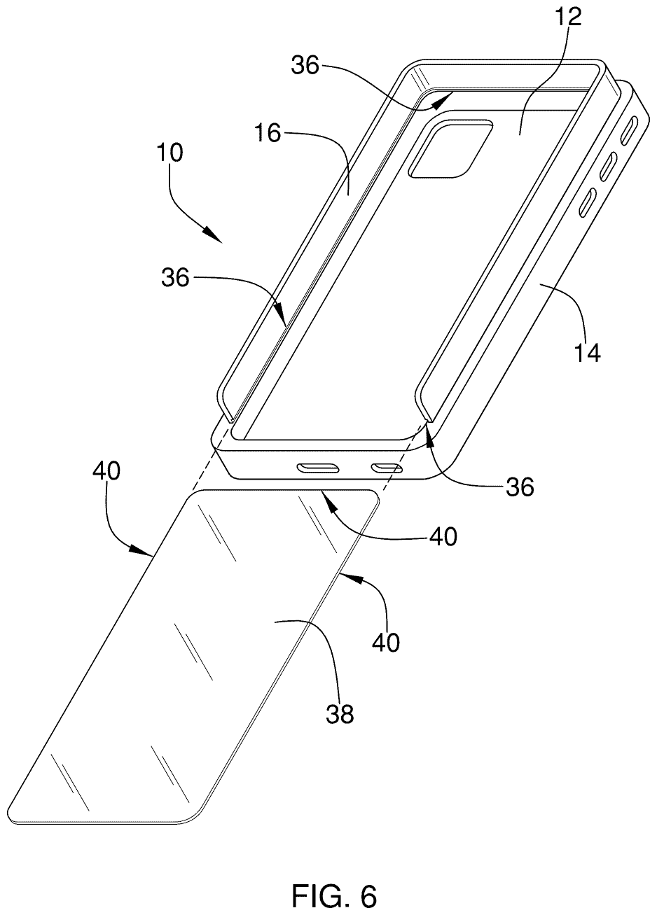

In an alternative embodiment shown in FIG. 6, the mobile phone case 10 includes a recessed groove 36. The recessed groove 36 is formed in the sun-shade wall 16 adjacent the peripheral wall 14. The recessed groove 36 extends along the entirety of the sun-shade wall 16. The recessed groove 36 is designed to receive peripheral edges 40 of an anti-glare insert 38 to hold the anti-glare insert 38 over a screen 62 of the mobile phone 60 in the mobile phone case 10. The anti-glare insert 38 can be provided as part of the mobile phone case 10 or could be provided separately.

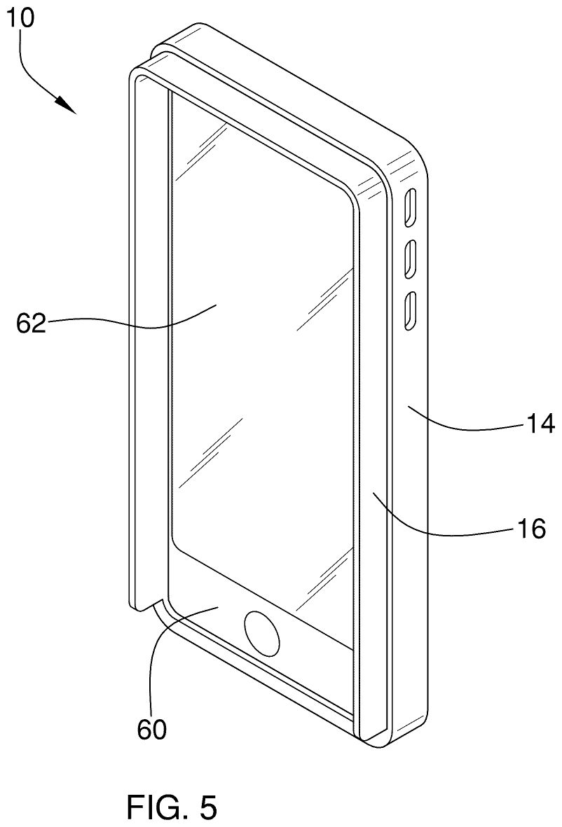

As shown in FIG. 5, the mobile phone case 10 is used to hold a mobile phone 60. The mobile phone 60 is inserted into the mobile phone case 10 in a snap-fit or similar manner with the peripheral wall 14 fitting snugly around the mobile phone 60. The sun-shade wall 16 provides shade to help a user to better view the screen 62 of the mobile phone 60 with reduced glare or reflection of sunlight or other ambient light.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A mobile phone case comprising:
a back wall;
a peripheral wall being disposed about and extending perpendicularly from a perimeter edge of said back wall, said peripheral wall being configured to extend around a mobile phone in the mobile phone case, said peripheral wall including a top wall portion, a bottom wall portion, a first side wall portion, and a second side wall portion; and
a sun-shade wall integrally formed with and projecting from said peripheral wall in a direction perpendicular to said back wall, said sun-shade wall being U-shaped and extending along said first side wall portion, said top wall portion, and said second side wall portion of said peripheral wall.

2. The mobile phone case of claim 1, wherein said peripheral wall includes a perimeter lip portion extending along said peripheral wall and projecting inwardly in a direction parallel to said back wall, said perimeter lip portion is configured to retain the mobile phone in the mobile phone case, said perimeter lip portion includes a perimeter lip edge, and said sun-shade wall has an inner surface that extends from said perimeter lip edge of said perimeter lip portion.

3. The mobile phone case of claim 1, wherein said sun-shade wall has a height similar to a height of said peripheral wall.

4. The mobile phone case of claim 1, further comprising openings in at least one of said back wall and said peripheral wall to permit access to components and ports of the mobile phone.

5. The mobile phone case of claim 1, further comprising a recessed groove, said recessed groove being formed in said sun-shade wall adjacent said peripheral wall, said recessed groove extending along the entirety of said sun-shade wall, said recessed groove being configured to receive peripheral edges of an anti-glare insert to hold an anti-glare insert over a screen of the mobile phone in the mobile phone case.

6. The mobile phone case of claim 5, further comprising the anti-glare insert removably inserted in said recessed groove.

7. A mobile phone case comprising:
a back wall;
a peripheral wall being disposed about and extending perpendicularly from a perimeter edge of said back wall, said peripheral wall being configured to extend around a mobile phone in the mobile phone case, said peripheral wall including a top wall portion, a bottom wall portion, a first side wall portion, and a second side wall portion, wherein:
said peripheral wall includes a perimeter lip portion extending along said peripheral wall and projecting inwardly in a direction parallel to said back wall, said perimeter lip portion is configured to retain the mobile phone in the mobile phone case, said perimeter lip portion includes a perimeter lip edge, and said sun-shade wall has an inner surface that extends from said perimeter lip edge of said perimeter lip portion;
a sun-shade wall integrally formed with and projecting from said peripheral wall in a direction perpendicular to said back wall, said sun-shade wall being U-shaped and extending along said first side wall portion, said top wall portion, and said second side wall portion of said peripheral wall, wherein said sun-shade wall has a height similar to a height of said peripheral wall; and
openings in at least one of said back wall and said peripheral wall to permit access to components and ports of the mobile phone.

8. The mobile phone case of claim 7, further comprising a recessed groove, said recessed groove being formed in said sun-shade wall adjacent said peripheral wall, said recessed groove extending along the entirety of said sun-shade wall, said recessed groove being configured to receive peripheral edges of an anti-glare insert to hold the anti-glare insert over a screen of the mobile phone in the mobile phone case.

9. The mobile phone case of claim 8, further comprising the anti-glare insert removably inserted in said recessed groove.
